(19) United States
(12) Patent Application Publication
(10) Pub. No.: US 2007/0079977 A1
(43) Pub. Date: Apr. 12, 2007

(54) Device for mounting a bulldozer blade at the front or the rear of a tractor

(76) Inventor: Hubert Defrancq, Guignicourt (FR)

Correspondence Address: YOUNG & THOMPSON, 745 SOUTH 23RD STREET, 2ND FLOOR, ARLINGTON, VA, 22202, US

(21) Appl. No.: 11/544,649

(22) Filed: Oct. 10, 2006

(30) Foreign Application Priority Data
Oct. 11, 2005 (FR) 05 10373

(51) Int. Cl. A01B 59/043

(52) U.S. Cl. 172/445.1

(57) ABSTRACT

Device for mounting a blade on the front or rear of a tractor fitted with a three-point lift namely two bottom points adapted to be subjected to the action of lifting element of the tractor, and a top middle point, the blade having three hitching points, namely two bottom hitching points and one top, middle hitching point capable of being connected to the three lift points of the tractor. The device includes, between each bottom hitching point of the blade and the associated bottom point of the lift, a link arm that is articulated at one end on the blade and, at its other end, on the associated bottom point of the lift, and at least one cylinder having one connected by articulation to at least one bottom arm, and the other end connected by articulation to the blade.

The invention relates to a device for mounting a blade, of the bulldozer blade type, at the front or the rear of a tractor, in particular an agricultural tractor, fitted with a three-point lift, namely with two bottom points capable of being subjected to the action of lifting means of the tractor, and a top, middle point, the blade or a blade support comprising three hitching points, namely two bottom hitching points and a top, middle hitching point, capable of being connected to the three lift points of the tractor.

Bulldozer blades are used for various agricultural tasks, particularly for forming heaps of silage, in particular of maize. A substantially vertical up or down movement of the blade is provided by the tractor lift, to which the blade is attached.

It is possible to provide a direct link between the blade and the three points of the lift, without a blade support, in which case the angular orientation of the blade to the right or to the left, by rotation about a vertical shaft, is not possible.

When the user desires to be able to angularly orient the blade to the left or to the right about a vertical shaft, this blade is mounted on a vertical shaft provided on a support with control means making it possible to modify the orientation of the blade about the vertical shaft. It is the support that is then connected to the three points of the lift.

When a tractor, fitted with a bulldozer blade, approaches a relatively steep slope, it frequently happens that the bottom edge of the blade, even lifted to the maximum by the tractor lift, scrapes the surface of the slope. This happens, for example, for the slope for accessing a silage heap whose height may reach two metres or more.

This disadvantage is more greatly felt the more the blade overhangs relative to the nearest tractor axle. The current tendency is to build tractors whose nose overhangs further relative to the front axle, which accentuates this problem.

It is also important to keep the vertical travel of the tractor three-point lift in a standard range, of the order of 650 to 900 mm, to retain the multi-purpose capability of the lift with other tools to be coupled to the tractor.

The main object of the invention is to provide a blade mounting device that is compatible with the coupling of the standard three-point lift while making it possible to increase the lift travel of the blade, and while avoiding substantially increasing the longitudinal overhang of the blade. The mounting device must also remain a low cost device.

According to the invention, a device for mounting a blade of the bulldozer blade type, at the front or rear of a tractor, in particular an agricultural tractor, fitted with a three-point lift, of the type previously defined, is characterized in that it comprises between each bottom hitching point of the blade, or of its support, and the associated bottom point of the lift, a link arm that is articulated at one end on the blade, or its support and, at its other end, on the associated bottom point of the lift, and at least one cylinder one end of which is connected by articulation to at least one of the arms, and the other end of which is connected by articulation to the blade or to its support, the variation in length of the cylinder allowing an additional height variation of the blade.

Preferably, the geometric axis of the cylinder is situated in a vertical longitudinal plane and, in the fully lowered position of the blade, the angle formed by this geometric axis and the arms is an obtuse angle. In the fully lowered position and in the fully raised position, the arms may form an acute angle with the vertical, the cylinder also forming an acute angle with the vertical.

According to a first possibility, the two arms are attached together by a crossbar. In this case, a single middle cylinder may be provided one end of which is articulated on the crossbar. This crossbar may form the base of a triangular frame, forming an interface, the top of which comprises two third-point hitching elements, the hitching element closest to the blade being provided for coupling a link rod between this point and the hitching point of the blade or of its support, while the second hitching element is provided in order to be connected to the top middle point of the lift.

Advantageously, the arm and the cylinder are designed to allow an additional vertical travel of at least approximately 650 mm.

The device may comprise at least one mechanical abutment of the blade against an arm in the fully lowered position of the blade to protect the cylinder against the stresses created by the pushing of the blade and amplified by the toggle joint type geometry. The depth adjustment of the blade during work is obtained with the lift of the tractor.

According to a variant, the two arms are independent and each controlled separately by at least one cylinder, the cylinder or cylinders of the two independent arms being able to be supplied in parallel or cross-supplied.

When the cylinders are supplied in parallel, they cause an additional lift of the blade as explained hereinbefore. When the cylinders are supplied by a cross-supply, one is deployed while the other is retracted which causes the blade to make an oscillation movement about a horizontal longitudinal shaft.

The cylinders of the two independent arms are advantageously supplied in series with a pipe connecting the two rod sides of the cylinders, while the piston side of each cylinder is connected to a directional flow valve for an oscillating movement of the blade about a horizontal longitudinal shaft.

To obtain an assembly allowing an inclination at an acceptable cost, the movement possibilities offered by the ball-and-socket connections of an agricultural tractor lift are exploited. For this, the link arms have a limited travel, so as not to exceed the orientation capabilities of the ball-and-socket joints, of the order of 8°. Each link arm is articulated at its end turned towards the lift on a ball-and-socket joint of one point of this lift. One of the arms is articulated at its other end on the blade or on the blade support by means of a bearing with a cylindrical shaft, while the other arm is articulated, at its end distant from the front lift, on the blade by means of a ball-and-socket joint. This solution eliminates the sliding stress on the lower coupling shafts and better reliability is the result thereof.

The hydraulic circuit supplying the cylinders comprises a main supply directional flow valve comprising a floating position making it possible to connect to the oil tank two orifices connected respectively to the piston side chamber of the two cylinders; one of the cylinders comprises a connecting bridge between the rod side and the piston side of the cylinder by means of a pipe in which a remotely controlled electric valve is inserted, the two rod sides of the cylinders being connected together; means of controlling the directional flow valve and the valve are provided to ensure the desired movements of the blade.

Apart from the dispositions explained hereinabove, the invention consists in a certain number of other dispositions which will be dealt with more explicitly hereinafter with reference to exemplary embodiments which are described with reference to the appended drawings, but which are in no way limiting.

The drawings show:

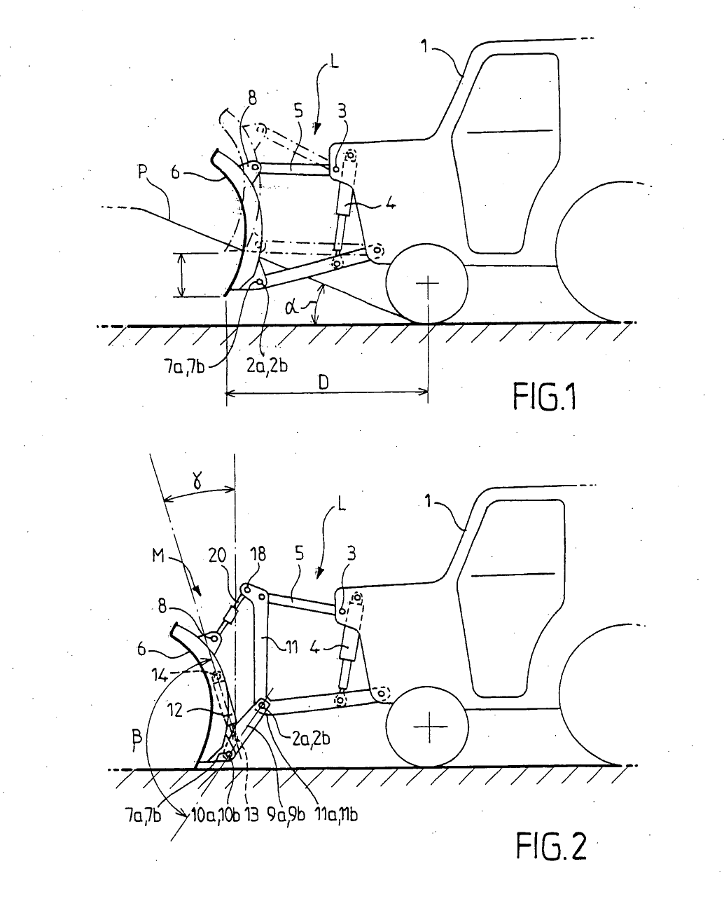

FIG. 1 is a schematic side view illustrating a tractor fitted, according to the prior art, with a bulldozer blade coupled to the front lift of the tractor going up a slope.

FIG. 2 is a schematic side view of a tractor fitted with a bulldozer blade and of the mounting device according to the invention.

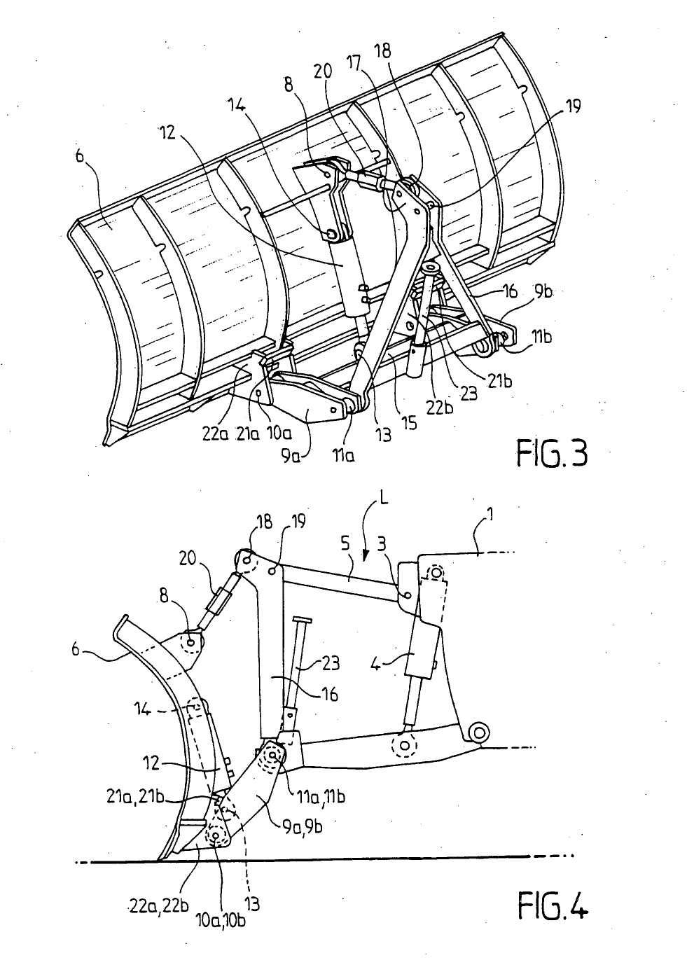

FIG. 3 is a three-quarter rear view in perspective of the blade and of the mounting device detached from the front lift.

FIG. 4 is a side view of the front lift fitted with the mounting device and the blade in the fully lowered position relative to the mounting device.

FIG. 5 shows, in a similar manner to FIG. 4, the assembly with the blade in the fully raised position relative to the mounting device, the front lift of the tractor remaining in the same position.

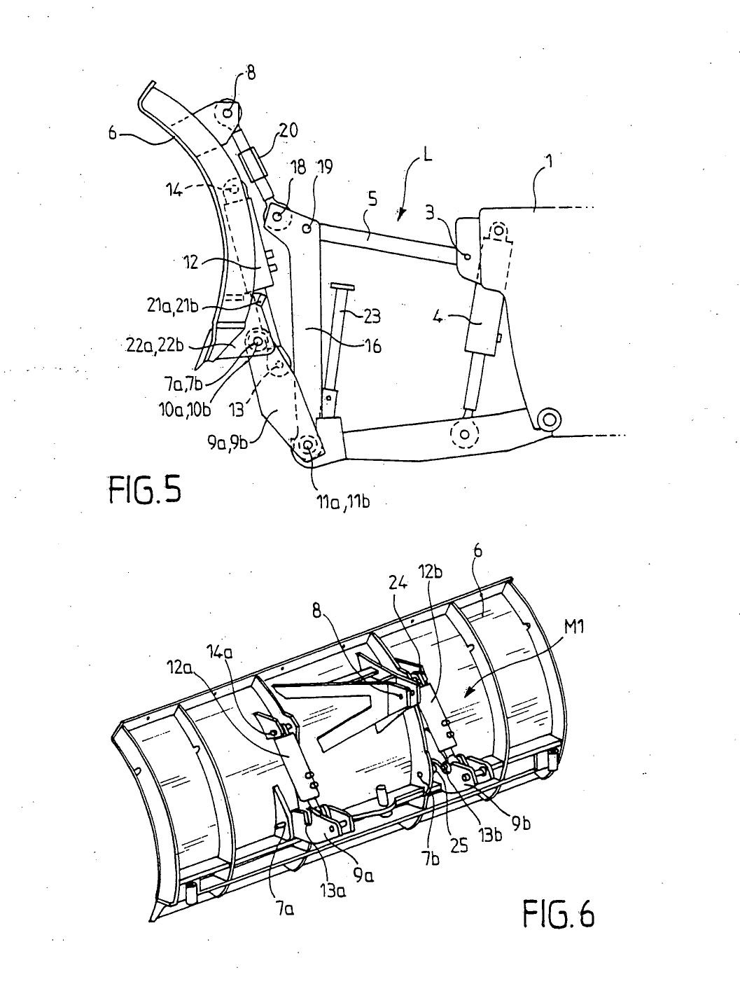

FIG. 6 is a three-quarter rear view of a blade with a variant of the mounting device according to the invention with two independent arms.

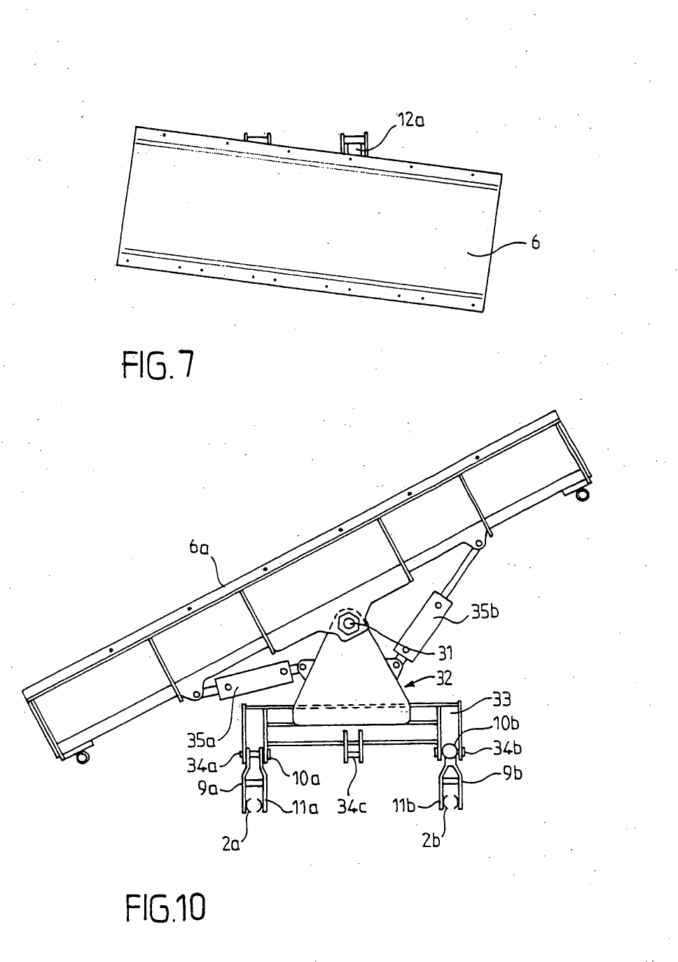

FIG. 7 is a front view of the blade of FIG. 6 in the inclined position, by rotation about a longitudinal horizontal shaft.

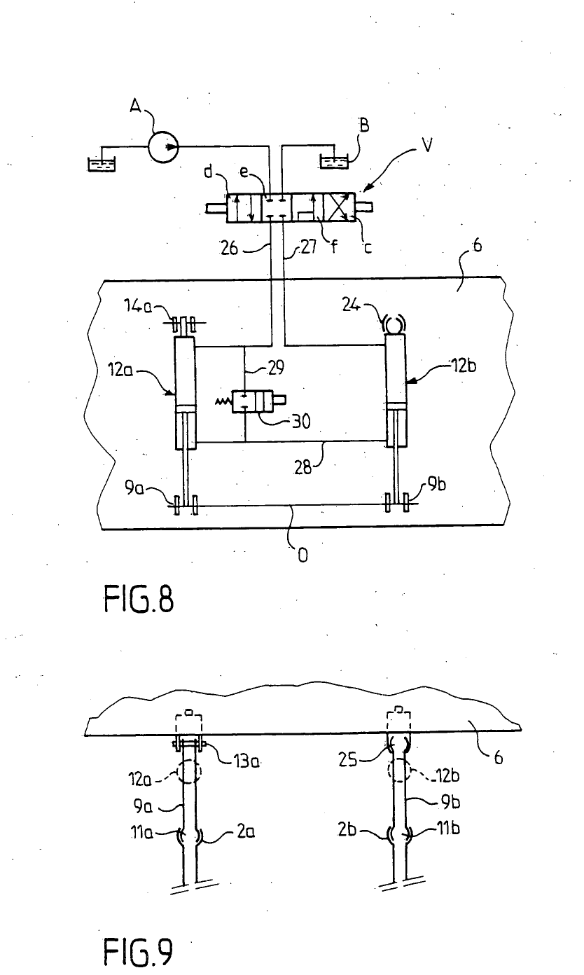

FIG. 8 is a partial schematic view in elevation of the rear of the blade of FIG. 6 with a schematic diagram of the hydraulic circuit.

FIG. 9 is a partial schematic top view relative to FIG. 8, and

FIG. 10 is a top view of a blade mounted on a support so that it can be oriented about a vertical shaft, the support being fitted with a mounting device according to the invention.

With reference to FIG. 1 of the drawings, an agricultural tractor 1 can be seen, fitted with a front lift L with three points, namely two bottom points 2a, 2b situated transversely either side of an imaginary extension of the tractor and one top, middle point 3. The points 2a, 2b are indistinguishable in orthogonal projection on the vertical plane of FIG. 1. The two bottom points 2a, 2b are subjected to the action of lift means 4. A link rod 5 is articulated on the top point 3. Front lifts of this type are known, see for example a lift according to U.S. Pat. No. 5,542,477 by Mr. Hubert DEFRANCQ, or the front lifts manufactured and marketed by the French company LAFORGE, address: Pôle d'Activités, Route de Soissons F-02190 GUIGNICOURT.

A blade 6, of the bulldozer blade type, comprises on its rear wall three hitching points, that it to say two bottom points 7a, 7b and a top, middle point 8. According to the prior art, illustrated by FIG. 1, the hitching points 7a, 7b are grasped and held by the bottom points 2a, 2b of the lift, while the top middle point 8 is connected to the top point 3 of the lift via the rod 5 that is of constant length, preferably adjustable.

When the lift means 4 are put into action, the blade 6 may be lifted up to a maximal fully raised position shown in dashed lines on FIG. 1.

The standard applicable to three-point lifts provides for a vertical travel lying within determined limits, currently 650 to 900 mm. This standard must be respected to retain the multipurpose capability of a front or rear lift with other agricultural implements.

For certain jobs, particularly when forming a silage heap of maize or other crops, the tractor fitted with the blade has to climb a slope P to gain access to the top part of the heap. It appears that the blade 6, even in the fully raised position, may catch on the slope P if the angle of slope α is greater than a relatively small limit. The front overhang D in the longitudinal direction of the front edge of the blade 6 relative to the front axle is an important factor: the greater the front overhang D for one and the same fully raised position of the blade 6, the smaller must be the angle α of slope P to prevent the bottom edge of the blade from scraping or catching.

According to the invention, as illustrated in FIG. 2, a mounting device M of the blade 6 is provided and comprises, between each bottom rear hitching point 7a, 7b of the blade and the associated bottom point 2a, 2b of the lift, a link arm 9a, 9b articulated at one end 10a, 10b to the points 7a, 7b on the rear wall of the blade. At its other end 11a, 11b, the arm 9a, 9b, is articulated on the corresponding point 2a, 2b of the lift.

The device M also comprises at least one cylinder 12, preferably double-acting, of which one end, for example the rod end oriented downwards, is connected via an articulation 13 to one of the arms 9a, 9b, or to a piece 15 (FIG. 3) fixedly attached to at least one of these arms. The other end of the cylinder 12, for example the end of the cylindrical body oriented upwards, is connected via an articulation 14 to the rear wall of the blade 6, for example via a clevis fixedly attached to this wall.

The articulation 13 of the end of the rod of the cylinder 12 is closer to the end (point) 10a, 10b for connection to the blade 6, than the end (point) 11a, 11b for connection to the lift L. Preferably, according to the orthogonal projection on the plane of FIG. 2, the distance between the articulation 13 and the points 10a, 10b is less than a third of the distance between the points 10a, 11a or between 10b and 11b.

In the fully lowered position of the blade 6 illustrated in FIG. 2, the angle β formed, in the forward direction, between the arm 9a and the geometric axis of the cylinder 12 is an obtuse angle that is advantageously greater than 100°. The geometric axis of the cylinder 12 is close to the vertical, the angle γ formed between this geometric axis and the vertical being advantageously less than 20°.

This disposition, of the toggle joint type for the cylinder 12, makes it possible to reduce the space requirement, in the longitudinal direction, of the hitching device M and therefore to limit the increase in the longitudinal overhang D.

According to the embodiment of FIG. 3 to FIG. 6, the two lower arms 9a, 9b (see FIG. 3) are attached together by a crossbar 15. The cylinder 12 is mounted halfway across the blade 6 and its bottom articulation 13 is provided in the middle of the crossbar 15 midway from the arms 9a, 9b. Means of delivering and discharging pressurized liquid are provided in the conventional manner for the cylinder 12 and are not described in greater detail.

A frame 16 (FIG. 3) in the form of an isosceles triangle, with a horizontal base, is provided. This frame is articulated at the bottom part to the end points 11a, 11b. Its top comprises a post 17 protruding forwards, in which two longitudinally offset hitching points 18, 19 are provided. The hitching point 18 situated towards the front is connected via a rod 20 of constant length, preferably unadjustable, to the top middle hitching point 8 of the blade 6. The rear point 19 is designed to be connected via the rod 5 to the top middle point 3 of the front lift. The two bottom points 2a, 2b of the front lift come to be coupled to the hitching points 11a, 11b of the ends.

The intermediate triangle 16 allows the geometry of the three-point linkage of the front lift to be unaffected by the vertical movement of the blade. The two hitching points 18, 19 in the fully raised position make it easier to unhitch the blade 6 while retaining the triangle 16.

The bottom hitching points 11a, 11b may be formed by a shaft onto which is engaged a ball comprising a bore traversed by the shaft. The ball forms a ball-and-socket joint for the link with coupling arms usually forming the bottom points 2a, 2b of the lift.

A bottom stop 21a, 21b is provided on the blade 6 in order to lock in the fully lowered position (FIG. 4) of the blade against a matching stop zone of the corresponding arm 9a, 9b. The stop 21a, 21b may be formed by a plate welded onto two cheeks 22a, 22b fixedly attached to the rear wall of the blade 6, and framing the front end of each arm 9a, 9b. The cheeks 22a, 22b comprise holes forming bearings for the articulation points 10a, 10b. Thus, in the fully lowered position of the blade 6, the mechanical latch 21a, 21b makes it possible to prevent the cylinder 12 from sustaining very high pushing stresses due to the toggle joint effect.

A stand 23 is mounted slidingly, in a substantially vertical direction, in a cylindrical sleeve attached to the base of the triangle 16. A pin-based system for locking the stand 23 in the fully raised and lowered position (FIG. 4) is provided. In the fully lowered position, the stand 23 makes it possible to keep the blade 6 in the fully raised position on the ground when it is separated from the lift.

Preferably, the arms 9a and 9b are parallel to the connecting rod 20 so that, seen from the side as illustrated in FIGS. 2 and 3, the points 10a, 10b; 11a, 11b; 18 and 8 form tops of a parallelogram that can be deformed by modifying the length of the cylinder 12. The value of the parallelogram is to provide a movement of the blade 6 parallel to itself. It should be noted that the device can operate even if the quadrilateral having for tops the points 10a,10b; 11a, 11b; 18 and 8 is not a parallelogram. In this case, the deformation of the quadrilateral under the action of the cylinder 12 causes the orientation of the blade 6 to be modified. However, it is imperative not to change the features thereof, once defined, to ensure a correct operation of the stops 21a, 21b.

This being so, the device operates as follows.

The fully lowered position (FIG. 4) of the blade 6, relative to the frame 16, is obtained when the rod of the cylinder 12 is retracted giving the cylinder assembly a minimum length. In this configuration, the stops 21a, 21b provided at the rear of the blade 6 are pressing against the arms 9a, 9b. To lower the blade 6 and modify the working of the ground or of a surface, the front lift L of the tractor is then used.

When the user wants to raise the blade 6 relative to the frame 16, the cylinder 12 is supplied so as to cause the blade 6 to move to the fully raised position relative to the intermediate frame 16, as illustrated in FIG. 5.

Observing the fully lowered position of the arms 9a in FIG. 4 and their fully raised position in FIG. 5, it appears that these arms are close to the descending vertical in FIG. 4 or ascending vertical in FIG. 5. Thus a maximum vertical travel is obtained with a minimum length of arm 9a, 9b. The cylinder 12 remains close to the vertical.

With arms 9a, 9b whose length is of the order of 40 cm, the additional lift travel may be of the order of that provided by the front lift. The increased lift travel of the blade 6 permitted by the device M is far greater than that required by the increase in the longitudinal overhang D due to the mounting device M. It is approximately three times the increase in the overhang due to the device M.

In order to approach a slope P, the front lift of the tractor is placed in the fully raised position as is the blade 6 relative to the frame 16 so that the two vertical travels are added together. Thus the tractor 1 may, for example, ascend a steep slope P without risk of catching the bottom edge of the blade when it is in the fully raised position. Naturally, the value of the increase in the vertical travel is not limited to this example.

With reference to FIG. 6, a variant embodiment can be seen which makes it possible to cause the blade 6 to oscillate through a limited angle, of the order of ±8° about a longitudinal horizontal shaft, parallel to the direction of travel of the tractor. FIG. 7 shows, in front view, the blade 6 thus inclined whose right side is lower than the left side.

The mounting device M1, forming the interface between the blade 6 and the front three-point lift, also comprises two link arms 9a, 9b between the hitching points 7a, 7b of the blade and the lift. But, according to this variant, the two arms 9a, 9b are independent, not being connected via a crossbar. Each arm 9a, 9b may therefore pivot in a different manner.

Each arm 9a, 9b is associated with a cylinder 12a, 12b, preferably double-acting, whose geometric disposition relative to the blade 6 and to the arms 9a, 9b is similar to that of the preceding figures. Each cylinder 12a, 12b therefore has its geometric axis situated in a vertical longitudinal plane; in the fully lowered position of the blade, the geometric axis of the cylinder forms, towards the front, an obtuse angle with the corresponding arm, the cylinder being close to the vertical direction. Preferably, the cylinder rod is directed downwards and the cylinder is directed upwards. The geometric axes of the cylinders 12a, 12b are parallel with one another when the rectilinear top and bottom edges of the blade 6 are horizontal.

One of the arms, for example 9a, is articulated to the point 7a fixedly attached to the blade by a cylindrical shaft-cylindrical bearing assembly.

The other arm 9b is connected to the blade 6 by an articulation with ball-and-socket joint 25 which in particular allows an oscillating movement of the arm 9b substantially parallel to the horizontal plane.

The cylinder 12b, associated with the arm 9b, is connected at its top end to the blade 6 by a ball-and-socket joint 24 allowing, in particular, a swaying movement of the geometric axis of the cylinder 12b about the centre of the ball-and-socket joint 24 in a plane passing substantially through the geometric axes of the cylinders.

The variations of the distance separating the rear ends of the arms 9a, 9b induced by the oscillation movements are thus eliminated thanks to the assembly with ball-and-socket joints 24 and 25. The bottom end of the rod of the cylinder 12b is connected via the articulation 13b, which may be a ball-and-socket joint, or via a cylindrical shaft—cylindrical bearing assembly—with the arm 9b.

The third, top hitching point 8 of the blade 6 is provided at the rear of a kind of pyramid attached to the blade 6.

The cylinders 12a, 12b are hydraulically supplied by the circuit of FIG. 8 allowing a parallel supply of the cylinders in order to obtain a vertical lift of the blade 6 or a cross-supply of the cylinders for an oscillation of the blade as illustrated in FIG. 7.

The circuit of FIG. 10 comprises a directional flow valve V of which one inlet orifice receives the pressurized liquid from a pump A and of which an outlet orifice is connected to a tank B. Two orifices of the directional flow valve V are connected respectively by pipes 26 and 27 to the piston sides of the cylinders 12a, 12b. The two rod sides of the cylinders are connected together by a duct 28; a bridge is made between the rod side and the piston side of a cylinder, for example the cylinder 12a, by means of a pipe 29 in which a remotely controlled electric valve 30 is inserted.

The directional flow valve V is preferably a four-way valve, two positions c,d, for example extreme, corresponding respectively to the parallel supply of the piston sides of the cylinders and the cross-supply, a position e corresponding to complete closure and another position f being a floating position with the piston sides of the cylinders connected to the tank.

The operation is as follows.

When the electrically controlled electric valve 30 is open, placing the directional flow valve in the position d sends pressurized oil to the piston side and rod side of the cylinder 12a. Thus the cylinder 12a extends because the active section of the piston side is greater than that of the rod side, which causes the rod of the cylinder 12a to extend. The pressurized liquid is directed via the pipe 28 into the rod side chamber of the cylinder 12b whose piston side chamber is connected to the tank B. The cylinder 12b retracts.

This principle of pressurized hydraulic supply to the cylinder 12a with electrically controlled valve 30 allows a realignment of the oscillation in the case of a hydraulic leakage, usually on the rod side of the cylinders.

After the electrically controlled valve 30 is closed, the opposite movements of the rods of the cylinders 12a, 12b, under the effect of the transmission of oil by the directional flow valve V in one direction or the other, cause an oscillating movement of the blade 6 about a point O midway between the arms 9a, 9b. The oscillating movement is limited to approximately 8° on either side of the horizontal.

The opposite angular movements of the arms 9a, 9b cause an increase in the distance between the articulations of these arms with the cylinders. The mounting of the arm 9b connected via a ball-and-socket joint 25, on the blade side 6 makes it possible to eliminate the sliding stresses which would be caused by this change in the distance apart.

To obtain an oscillating movement of the blade 6 in the opposite direction, the valve 30 is closed and the directional flow valve V is placed in the position c so as to invert the movement of the pressurized oil. The pressure is admitted on the piston side of the cylinder 12b while the piston side of the cylinder 12a is connected to the tank. Under the action of the pressurized oil, the rod of the cylinder 12b extends while discharging, through the pipe 28, pressurized oil towards the rod side chamber of the cylinder 12a. The piston side chamber of this cylinder 12a being connected to the tank, the rod of the cylinder 12a will retract. There is oscillation in the other direction, in a symmetrical manner.

To return the device to the parallel, the valve 30 is opened and the directional flow valve V is placed in the floating position f with the blade 6 raised. In the floating position f, the two orifices of the directional flow valve V, to which the pipes 26, 27 are connected, are linked to the tank. By gravity, the two rods of the cylinder 12a, 12b enter the cylinders and the blade 6 lowers.

If it is desired to offset the blade 6 upwards, the directional flow valve V is also placed in the floating position f and the electric valve 30 is opened. The front lift of the tractor is lowered in order to place the blade 6 on the ground and pressure is put on this blade by the lift L being lowered. The rods of the cylinders 12a, 12b extend, the cylinders receiving oil to keep the blade 6 in the raised position once the directional flow valve V and the valve 30 are closed.

This particular operation provides an effective solution for oscillation of the blade, for correction of oil leakage and for positioning the blade 6 relative to the tractor. In addition, this mode of operation is not very sensitive to wear thanks to the mode of ball-and-socket joint connection available on the front lift of the tractor.

In the foregoing examples, the mounting device M is provided directly on the rear wall of the blade 6 which cannot be oriented in a horizontal plane.

FIG. 10 shows a blade 6a mounted so as to pivot about a vertical shaft 31 carried by a support 32 comprising, at the front, a triangular plate fixedly attached to a frame 33 furnished with three rear hitching points: two lateral, bottom points 34a, 34b and one top, middle point 34c.

The orientation of the blade 6a in a horizontal plane is controlled by cylinders 35a, 35b.

The mounting device of the invention is placed between the frame 33 of the support and the three points of the front lift of the tractor. FIG. 10 shows schematically the arms 9a, 9b of the mounting device connected to bottom hitching points of the frame 33. The cylinders 12a, 12b have not been shown. These cylinders would be mounted, in a manner similar to that illustrated in the preceding figures, between the frame 33 and the arms 9a, 9b.

The exemplary embodiments have been described with a front lift and a blade mounted on the front of the tractor. The explanations given remain valid for a mounting of the blade at the rear of the tractor on the rear lift, the tractor then working and moving in reverse.

1. Device for mounting a blade (6, 6a), of the bulldozer blade type, at the front or the rear of a tractor, in particular an agricultural tractor, fitted with a three-point lift (L), namely with two bottom points (2a, 2b) capable of being subjected to the action of lifting means (4) of the tractor, and a top, middle point (3), the blade or a blade support (32) comprising three hitching points, namely two bottom hitching points (7a, 7b; 34a, 34b) and a top, middle hitching point (8, 34c) capable of being connected to the three lift points of the tractor,
characterized in that it comprises between each bottom hitching point of the blade (7a, 7b), or of its support (34a, 34b), and the associated bottom point (2a, 2b) of the lift, a link arm (9a, 9b) that is articulated at one end (10a, 10b) on the blade, or its support and, at its other end (11a, 11b), on the associated bottom point (2a, 2b) of the lift, and at least one cylinder (12; 12a, 12b) one end of which is connected by articulation (13; 13a, 13b) to at least one of the arms, and the other end of which is connected by articulation (14; 14a, 24) to the blade or to its support, the variation in length of the cylinder (12; 12a, 12b) allowing an additional height variation of the blade (6, 6a).

2. Device according to claim 1, characterized in that the geometric axis of the cylinder (12; 12a, 12b) is situated in a vertical longitudinal plane and, in the fully lowered position of the blade (6; 6a), the angle (β) formed towards the front by this geometric axis and the arms is an obtuse angle.

3. Device according to claim 1, characterized in that, in the fully lowered position and in the fully raised position, the arms (9a, 9b) form an acute angle with the vertical, the cylinder (12; 12a, 12b) also forming an acute angle (γ) with the vertical.

4. Device according to claim 1, characterized in that the two arms (9a, 9b) are attached together by a crossbar (15).

5. Device according to claim 4, characterized in that only one middle cylinder (12) is provided, one end of which is articulated on the crossbar (15).

6. Device according to claim 4, characterized in that the crossbar (15) forms the base of a triangular frame (16), forming an interface, the top of which (17) comprises two third-point hitching elements (18, 19), the front hitching element (18) being provided for coupling a link rod (20) between this point and the hitching point (8) of the blade or of its support, while the second hitching point (19) is provided in order to be connected to the top middle point (3) of the front lift.

7. Device according to claim 4, characterized in that it comprises at least one mechanical abutment (21a, 21b) of the blade against an arm (9a, 9b) in the fully lowered position of the blade, to protect the cylinder (12) against the stresses created by the pushing of the blade.

8. Device according to claim 1, characterized in that the two arms (9a, 9b) are independent and each controlled separately by at least one cylinder (12a, 12b), the cylinders of the two independent arms being supplied in series with a pipe (28) connecting the two rod sides of the cylinders, while the piston side of each cylinder (12a, 12b) is connected to a directional flow valve (V) for an oscillating movement of the blade about a horizontal longitudinal shaft.

9. Device according to claim 8, characterized in that each link arm (9a, 9b) is articulated at its end turned towards the lift on a ball-and-socket joint of one point of this lift, one of the arms (9a) is articulated at its other end on the blade (6) by means of a bearing with a cylindrical shaft, while the other arm (9b) is articulated, at its end from the front lift, on the blade by means of a ball-and-socket joint (25).

10. Device according to claim 9, characterized in that the cylinder (12b) associated with the arm (9b) articulated on the blade by a ball-and-socket joint (25), is connected to the blade (6), at the top part, by a ball-and-socket joint (24).

11. Device according to claim 8, characterized in that the hydraulic circuit supplying the cylinders (12a, 12b) comprises a main supply directional flow valve (V) comprising a floating position (f) making it possible to connect to the oil tank (B) two orifices connected respectively to the piston side chamber of the two cylinders.

12. Device according to claim 8, characterized in that one (12a) of the cylinders comprises a connecting bridge between the rod side and the piston side of the cylinder by means of a pipe (29) in which a remotely controlled electric valve (30) is inserted, the two rod sides of the cylinders being connected together by a pipe (28), means of controlling the directional flow valve (V) and the valve (30) being provided to ensure the desired movements of the blade.

13. Device according to claim 2, characterized in that, in the fully lowered position and in the fully raised position, the arms (9a, 9b) form an acute angle with the vertical, the cylinder (12; 12a, 12b) also forming an acute angle (γ) with the vertical.

14. Device according to claim 2, characterized in that the two arms (9a, 9b) are attached together by a crossbar (15).

15. Device according to claim 4, characterized in that only one middle cylinder (12) is provided, one end of which is articulated on the crossbar (15).

16. Device according to claim 5 characterized in that the crossbar (15) forms the base of a triangular frame (16), forming an interface, the top of which (17) comprises two third-point hitching elements (18, 19), the front hitching element (18) being provided for coupling a link rod (20) between this point and the hitching point (8) of the blade or of its support, while the second hitching point (19) is provided in order to be connected to the top middle point (3) of the front lift.

17. Device according to claim 5, characterized in that it comprises at least one mechanical abutment (21a, 21b) of the blade against an arm (9a, 9b) in the fully lowered position of the blade, to protect the cylinder (12) against the stresses created by the pushing of the blade.

18. Device according to claim 6, characterized in that it comprises at least one mechanical abutment (21a, 21b) of the blade against an arm (9a, 9b) in the fully lowered position of the blade, to protect the cylinder (12) against the stresses created by the pushing of the blade.

19. Device according to claim 2, characterized in that the two arms (9a, 9b) are independent and each controlled separately by at least one cylinder (12a, 12b), the cylinders of the two independent arms being supplied in series with a pipe (28) connecting the two rod sides of the cylinders, while the piston side of each cylinder (12a, 12b) is connected to a directional flow valve (V) for an oscillating movement of the blade about a horizontal longitudinal shaft.

20. Device according to claim 9, characterized in that the hydraulic circuit supplying the cylinders (12a, 12b) comprises a main supply directional flow valve (V) comprising a floating position (f) making it possible to connect to the oil tank (B) two orifices connected respectively to the piston side chamber of the two cylinders.
